(19) United States
(12) Patent Application Publication
(10) Pub. No.: US 2002/0017209 A1
(43) Pub. Date: Feb. 14, 2002

(54) Method and device for clearing a re-imageable printing form

(76) Inventors: Martin Gutfleisch, Dossenheim (DE); Martin Schmitt-Lewen, Heidelberg (DE)

Correspondence Address: LERNER AND GREENBERG, P.A., Post Office Box 2480, Hollywood, FL, 33022-2480, US

(21) Appl. No.: 09/923,696

(22) Filed: Aug. 6, 2001

(30) Foreign Application Priority Data
Aug. 4, 2000 (DE) 10037988.2

(51) Int. Cl. B41F 1/00; B41F 35/00

(52) U.S. Cl. 101/424

(57) ABSTRACT

A method for clearing a re-imageable printing form, includes treating the printing form with a fluid clearing medium; a device for performing the method; and a printing machine including the device.

### BACKGROUND OF THE INVENTION

1. Field of the Invention

The invention relates to a method and a device for clearing a re-imageable printing form from which the ink has been washed. The most important printing method today, the offset method, is predicated on the immiscibility of water and grease-based ink. Non-printing points on an offset printing form are processed so as to be put into a hydrophilic state, i.e., they accept water or a dampening solution, whereas the printing points on an offset printing form are present in a hydrophobic state, i.e., they do not accept water or dampening solution. In the dampening of the printing form, which is placed on a plate cylinder, for example, only the hydrophilic points are wetted, so that in the subsequent inking of the printing form, the grease-based ink is applied to the printing form only at the hydrophobic and thus lipophilic locations, i.e., at those locations which accept fat. The printing image which is generated in this way is then transferred from the plate cylinder to a rubber blanket cylinder and from there to a recording medium such as paper, cardboard or foil under pressure. The offset method is thus an indirect method of printing.

Conventional printing forms used in offset printing are formed primarily of precoated aluminum plates with a printing area that has been roughened at the non-printing locations by mechanical and/or electrolytic processes, so that fine pores or capillaries emerge at these locations, which accept and hold the dampening solution film. At the printing locations, on the other hand, the printing forms have a fine closed surface which does not accept dampening solution but provides the ink with a highly adhesive substratum. These printing forms can only be imaged once, however; it is impossible subsequently to clear the printing image and to re-image with a new printing image.

There are also heretoforeknown printing forms which can be imaged many times. These printing forms have a surface which can be converted reversibly from a hydrophobic state into a hydrophilic state.

The published European Patent Document EP 0 911 154 A1 describes such a printing form, which has a surface coated with titanium oxide or zinc oxide. The surface characteristic of this printing form changes from the hydrophobic state into the hydrophilic state under the influence of UV radiation having a wavelength of less than 400 nm, preferably. This printing form can also be converted back into the hydrophobic state, which also represents the lipophilic state, under the influence of heat, which can be supplied by an infrared laser or a heating element arrangement. The printing image is then generated in that the coated printing form, which is originally in the hydrophobic, i.e. lipophilic, state, is irradiated with UV radiation surface-wide and thus becomes hydrophilic surface-wide. Next, heat is delivered locally to the locations to be printed, for example, using the heating element, the printing form being locally imaged thereby, i.e., becoming lipophilic locally. Next, ink and dampening solution are applied to the surface of the printing cylinder, the ink and dampening solution adhering only at the respective locations which pick them up, with the result that the printing form is prepared for printing. Following the performance of the printing process, the ink is first washed from the printing form in a washing device, and the printing form is then converted back into the surface-wide hydrophilic state under the renewed effect of UV radiation. The printing image is thus cleared from the printing form which can then undergo an additional imaging process.

The published European Patent Document EP 0 911 155 A1 also discloses a printing form which is coated with titanium oxide or zinc oxide and which can be converted into the hydrophilic state using UV radiation and into the lipophilic state using heat, just as the printing form described in the aforementioned published European Patent Document EP 0 911 154 A1. The described printing form is initially in the lipophilic state and is subjected to UV radiation only locally at the non-printing locations, in order to convert these locations into the hydrophilic state. Accordingly, the printing form is negatively imaged. After printing, the printing form is first washed of the residual ink and then converted back into the lipophilic state surface-wide by heat treatment, thereby clearing it and readying it for an additional imaging process.

However, the described clearing of the printing form requires a period of several minutes, e.g., 10 minutes at a temperature of approximately 150° C. This period can be shortened only by raising the temperature. For example, to achieve a clearing time of 10 seconds, the temperature during heat treatment must be raised beforehand to 250° C. A successive reduction of the clearing time is hindered, on the one hand, by temperature compatibility, particularly the destruction of the oxide layer by heat, and on the other hand, by temperature sensitivity, both of the clearing device, which may be located in the printing machines, and of the printing machine itself. But in the specific case of computer-to-printing machine applications, i.e., in applications wherein image data are fed from a computer directly into the printing machine, the imaging and clearing of the printing forms should occur in the printing machine and, at the same time, the duration of the two processes, particularly the duration of the clearing process, should be minimized in order to be able to carry out a rapid change of printing jobs. In order to accomplish this, a printing form which is cleared as described in the prior art would have to be heated to an extraordinary degree and would then have to pass through a cooling phase prior to the subsequent imaging process, the total duration of the re-imaging process being thereby disadvantageously extended.

It has also become known heretofore that the hydrophilic effect of the printing form varies within hours or weeks when it is stored in the dark, depending upon the titanium dioxide modification. On the molecular level, OH groups that cause the hydrophilic behavior are shed, and oxygen bonds in place thereof, giving the surface a hydrophobic character.

The printing forms used as the re-imageable printing forms are recoated with an imageable surface in a coating process following the washing process. This does not involve modifying and clearing the relevant surface layer on the molecular level; rather, a layer that has already been imaged is covered with a layer that has not yet been imaged.

### SUMMARY OF THE INVENTION

Accordingly, it is an object of the invention of the instant application to provide a method and a device for clearing re-imageable printing forms in a shorter time than heretofore.

With the foregoing and other objects in view, there is provided, in accordance with one aspect of the invention, a method for clearing a re-imageable printing form, which comprises treating the printing form with a fluid clearing medium.

In accordance with another mode, the method of the invention includes cleaning the printing form of ink, and treating the cleaned printing form with a fluid clearing medium.

In accordance with a further mode, the method of the invention includes treating the printing form with a liquid clearing medium.

In accordance with an alternative mode, the method of the invention includes treating the printing form with a gaseous clearing medium.

In accordance with an added mode, the method of the invention includes treating the printing form with ultrasound during the treatment thereof with the fluid clearing medium.

In accordance with an additional mode, the method of the invention includes exposing the printing form to the effects of a heat source during the treatment thereof with the fluid clearing medium.

In accordance with yet another mode, the method of the invention includes providing at least one of an infrared laser, at least one heat emitter and at least one hot-air blower as the heat source.

In accordance with yet a further mode, the method of the invention includes exposing the printing form to higher than normal atmospheric pressure during the treatment with the fluid clearing medium.

In accordance with yet an added mode, the method of the invention includes providing water as the fluid clearing medium.

In accordance with yet an additional mode, the method of the invention includes providing an acid as the fluid clearing medium.

In accordance with still another mode, the method of the invention includes providing an alkali or base as the fluid clearing medium.

In accordance with still a further mode, the method of the invention includes applying the fluid clearing medium to the printing form from at least one sprayer.

In accordance with still an added mode, the method of the invention includes removing the printing form from the influence of light during the treatment with the gaseous clearing medium.

In accordance with still an additional mode, the method of the invention includes providing oxygen as the gaseous clearing medium.

In accordance with another mode, the method of the invention includes performing the steps thereof in one of a printing machine and a clearing device outside a printing machine.

In accordance with a further aspect of the invention, there is provided a device for clearing a re-imageable printing form, comprising a device for applying fluid clearing medium to the printing form.

In accordance with another feature, the device of the invention includes a device for applying fluid clearing medium to the ink-free printing form. In accordance with a further feature, the device for applying fluid clearing medium serves for applying liquid clearing medium to the printing form.

In accordance with an added feature, the device for applying fluid clearing medium serves for applying gaseous clearing medium to the printing form.

In accordance with an additional feature, the device of the invention includes an ultrasound source for irradiating the printing form with ultrasound.

In accordance with yet another feature, the device of the invention includes a heat source for heating the printing form.

In accordance with yet a further feature, the heat source is at least one of an infra-red laser, at least one heat emitter, and at least one hot-air blower.

In accordance with yet an added feature, the device of the invention includes a device for generating higher than normal atmospheric pressure in the environment of the printing form.

In accordance with yet an additional feature, the device for applying fluid clearing medium to the printing form is a sprayer.

In accordance with another feature of the invention, the device of the invention includes a device for partitioning the printing form against effects of light.

In accordance with a concomitant aspect of the invention, there is provided a printing machine having a device for clearing a re-imageable printing form, comprising a device for applying fluid clearing medium to the printing form.

The method of the invention for clearing a re-imageable printing form, particularly a printing form from which the ink has been washed, is distinguished by the printing form being treated with a fluid, i.e., a liquid and gaseous, respectively, clearing medium.

Because the printing form is treated with a liquid or gaseous clearing medium in accordance with the invention, the clearing process can be advantageously carried out in a very short time. The effect of the clearing medium on the surface of the printing form, which can be a titanium dioxide layer, for example, converts it from the hydrophilic state into the hydrophobic state or the reverse. The person practising the method of the invention is thus able to carry out the clearing of the re-imageable printing forms in a short enough time so that printing forms in computer-to-press applications can be cleared using the method according to the invention. But it is also possible, prior to re-imaging, to clear printing forms very quickly outside a printing press after removing the printing forms from a printing cylinder in the printing press, and then to reinsert them into the printing press.

In another mode of the method according to the invention, the printing form can be treated with ultrasound during the treatment with the liquid clearing medium or solution. By treating the printing form with the liquid clearing solution and ultrasound simultaneously, the duration of the clearing process is advantageously further reduced. The clearing process can be carried out both in the printing press and outside the printing press in an ultrasound bath, the liquid clearing solution constituting at least part of the immersion bath fluid. Upon completion of the clearing process, the surface of the printing form is in a hydrophobic state.

In another mode of the method according to the invention, provision can be made for the printing form to be subjected to the effects of a heat source during treatment with the liquid clearing solution. The time required for clearing the printing form is further reduced by the effect of the heat source on the printing form during the treatment with the liquid clearing solution. The printing form can be exposed to the heat source inside the printing press. But, provision can also be made for the heat source to act upon the printing form outside the printing press. In either case, at least one infrared laser, at least one heat emitter and/or at least one hot-air blower can be used as the heat source. Provision can also be made for the power of the heat source to be variable, namely that it be adjustable automatically by hand. When water is used as the clearing medium, and heat is simultaneously added, the relevant outer layer of the printing form is converted back into a thoroughly hydrophobic state.

It is also possible to expose the printing form to higher than normal atmospheric pressure in the execution of the method of the invention during treatment with the liquid clearing medium. Raising the atmospheric pressure simultaneously raises the boiling point of the liquid medium, and it is thus possible to carry out the clearing process at a temperature which is higher than the boiling point of the liquid medium at normal pressure. Thus, in another advantageous mode of the method of the invention, provision can be made for water to be used as the liquid clearing medium. On the one hand, using water as the clearing medium for re-imageable printing forms saves the user considerable costs, because water is very inexpensive, and on the other hand, it facilitates the process considerably, because there is usually a water connection in the vicinity of such a printing press, particularly in the vicinity of a lithographic offset printing press. When water is used as the clearing medium, if the atmospheric pressure has been raised above normal pressure as mentioned hereinbefore, the temperature of the clearing medium can be raised above 100° C. under the influence of the heat source.

It is also possible to use an acid or alkali as the liquid clearing medium or solution in the method of the invention. In this chemical clearing process, the surface of the printing form is converted back into a uniformly hydrophobic or hydrophilic state, depending upon the acid or alkali that is used.

A preferred development of the method of the invention is also distinguished by the use of at least one spraying device for applying the liquid clearing medium to the printing form. In this way, a uniform superficial application of the liquid medium onto the printing form is achieved, for which a very precise metering of the clearing medium can be carried out by adjusting the spray nozzle, and by adjusting the pressure with which the clearing medium is applied, respectively.

In another development of the method of the invention, the printing form can be deprived of light during treatment with the gaseous clearing medium, which can be oxygen, for example. Treating the printing form with an excess of oxygen in a dark environment brings the entire printing form back into a uniform hydrophobic state and thus clears an existing printing image from the printing form. The clearing process can be carried out inside the printing press, with darkening to the greatest extent of the region about the printing form cylinder on which the printing form is located, for example, with the aid of a partitioning device, and with pure oxygen being delivered to the surface of the printing form with the aid of one or more delivery devices, for example, in the form of jet nozzles.

In general, all of the aforedescribed modes of the method of the invention can be carried out either inside or outside a printing press, and only the devices with which the method is carried out must be adapted to the corresponding conditions, particularly the conditions inside a printing press. Thus, for spray devices, provision can be made for the environment about the spray device in a printing press to be protected from the effects of the sprayed clearing medium by an additional partitioning device. It is also possible to provide additional suction devices for sucking out the excess clearing medium.

The aforedescribed advantageous developments of the method of the invention wherein the printing form is subjected to higher than normal atmospheric pressure can be expediently carried out outside the printing press in separate clearing devices. Such devices comprise a chamber, wherein the printing form is disposed during the clearing process, and which can be sealed pressure-tightly and pressurized to a pressure higher than normal air pressure with the aid of an excess-pressure unit, for example, a compressor.

The device according to the invention for clearing a re-imageable printing form from which the ink has been washed is distinguished by having a device for applying gaseous or liquid clearing medium to the printing form. The device for applying clearing medium to the printing form can be a spray device, having particularly one or more spray nozzles, a form roller, a cloud chamber, or a device for applying the medium by electrostatically charging the medium and the printing form. The device can also comprise a unit for adjusting the metering of the clearing medium during the application thereof to the printing form. The described devices for applying a clearing medium to the printing form make it possible for the pressman to apply the medium to the printing form surface-wide and in the desired dosage, thereby making it possible to create optimal conditions for clearing the re-imageable printing form, and thus to carry out the clearing process, in a short time.

Additional embodiments of the device of the invention provide an ultrasound source for irradiating the printing form with ultrasound, or a heat source for heating the printing form. At least one infrared laser, at least one heat emitter, and/or at least one hot-air blower can be used as the heat source. The ultrasound source and the heat source can be arranged in the vicinity of the printing form cylinder downline from the device for applying the clearing medium to the printing form, as viewed in the direction of rotation of the printing form cylinder, the ultrasound and the heat, respectively, acting directly upon the printing form after it has been pretreated with clearing medium.

There are imaginable printing processes which are distinguished in that the previous image is cleared and the printing form is re-imaged with each rotation of the printing form cylinder. A fast and fast-acting clearing process is necessary therefor, for which the method and device of the invention can be used, to the extent that they can be carried out “on press”.

Other features which are considered as characteristic for the invention are set forth in the appended claims.

Although the invention is illustrated and described herein as a method and device for clearing a re-imageable printing form, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is a flowchart in the form of a block diagram of the method according to the invention, which calls for treating the printing form with ultrasound;

FIG. 2 is a flowchart in the form of a block diagram of the method according to the invention, which calls for treating the printing form with water while heat is added;

FIG. 3 is a flowchart in the form of a block diagram of the method according to the invention, which calls for treating the printing form with oxygen while it is being removed from light;

FIG. 4 is a diagrammatic and schematic side elevational view of the device according to the invention, including a spray device and an ultrasound source;

FIG. 5 is a view similar to that of FIG. 4 of the device according to the invention, including an infrared laser instead of the ultrasound source;

FIG. 6 is a view similar to that of FIG. 4 of the device according to the invention, including a heat emitter instead of the ultrasound source;

FIG. 7 is a view similar to that of FIG. 4 of the device according to the invention, including a plurality of spray devices instead of one thereof, and a hot-air blower instead of the ultrasound source; and

FIG. 8 is a view similar to that of FIG. 4 of the device according to the invention, including a partitioning device instead of the ultrasound source.

### DESCRIPTION OF THE PREFERRED EMBODIMENTS

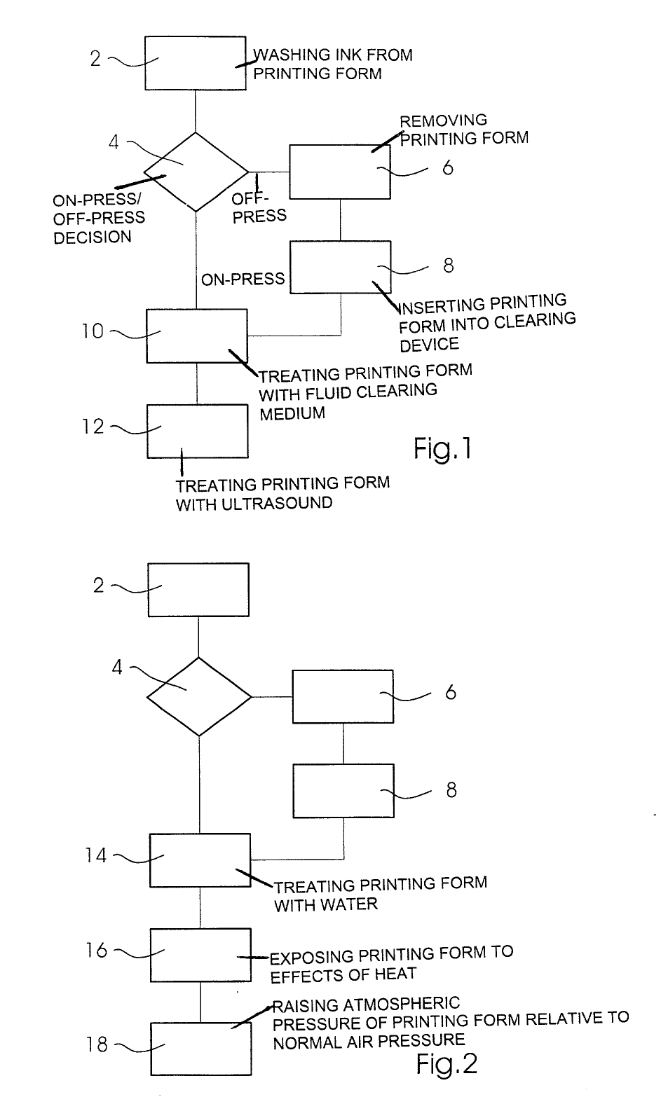

Referring now to the drawings and, first, particularly to FIG. 1 thereof, there is shown therein a flowchart in the form of a block diagram of the method for clearing a re-imageable printing form, including a first step 2 wherein the ink is initially washed from the printing form. This washing process can be carried out with the aid of a heretoforeknown washing device. In a subsequent step 4, a determination is made as to whether the clearing process will be subsequently executed inside the printing press (on press) or outside the printing press (off press). If the clearing process is to be performed off press, in a step 6, the printing form is removed from the printing cylinder and, in the next step 8, is inserted into a clearing device which is external to the printing press. The printing form can be constructed as a plate or as a cylinder, a plate-type printing form being fixed to the printing form cylinder by a heretoforeknown plate clamping mechanism, and a cylindrical printing form being pushed onto the printing form cylinder and pulled therefrom axially. The printing form, which has a titanium dioxide layer at the surface thereof, is then treated with a liquid clearing solution in step 10, which can be applied to the printing form with the aid of an application device such as a sprayer, or the printing form can be inserted into an immersion bath composed at least partly of the liquid clearing solution.

The method of clearing the printing form with the aid of an immersion bath is preferably utilized in the off-press embodiment of the method according to the invention. The treatment of the printing form with a liquid solution in step 10 converts the printing form into a hydrophilic or hydrophobic state surface-wide, depending upon the type of solution used, thereby irreversibly clearing all image information on the surface of the printing form. Hydrogen peroxide H₂O₂ can be used to convert the surface layer 36 of the printing form back into the hydrophobic initial state, while the surface layer 36 can be converted into the hydrophilic initial state using sodium hydroxide NaOH. A 30% aqueous solution of H₂O₂ and a 20% aqueous solution of NaOH can be used therefor. To further support this clearing process, in step 12 the printing form is additionally treated with ultrasound during the treatment with liquid solution. The added energy that is supplied by the ultrasound further supports and shortens the clearing process. The ultrasound that is used is preferably in the frequency range between 30 kHz and 50 kHz.

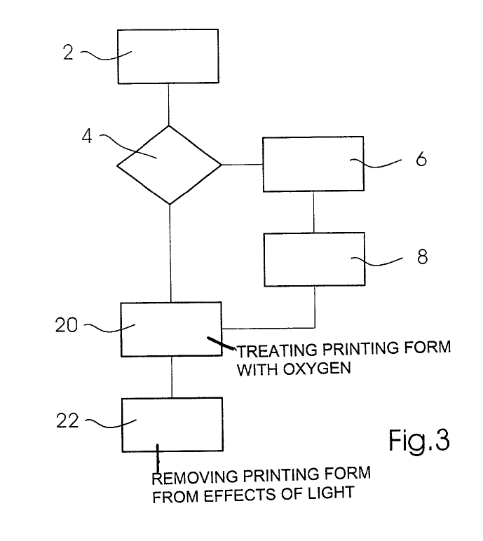

FIG. 2 illustrates another mode of the method according to the invention, wherein the printing form is treated with water serving as the liquid clearing solution and is exposed to the effects of a heat source. Steps 2, 4, 6 and 8 are the same as the correspondingly identified steps described in FIG. 1. In step 14, the printing form is initially treated with water serving as the liquid clearing solution. This can be a matter of common tap water or of specially prepared clearing water which has undergone a distillation process. In the subsequent step 16, the printing form is additionally exposed to the effects of a heat source in order to support the clearing process. The addition of heat energy, for example, in the form of thermal radiation, effectuates an advantageous support of the clearing process and a further reduction of the duration thereof. A subsequent step 18 includes increasing the atmospheric pressure of the printing form relative to normal air pressure during the treatment of the printing form with water serving as the liquid clearing medium, as well as the addition of heat energy. Increasing the atmospheric pressure makes it possible to execute the clearing of the printing form at temperatures above 1000 C, using water as the liquid clearing medium, and thus to further shorten the duration of the clearing process. Tempering the printing form 36, i.e., the surface thereof, to a temperature in the range between 50° C. and 120° C. has proven to be an advantageous way to support the clearing medium-induced clearing process.

FIG. 3 provides another flowchart of the method according to the invention, wherein the steps 2, 4, 6, and 8 conform to the methods represented in FIGS. 1 and 2. In the subsequent step 20, the printing form is treated with oxygen serving as a gaseous clearing medium, as a result of which the printing form is converted into a hydrophobic state surface-wide, and all image information on the surface of the printing form disappears. To support the clearing process, provision can be made for the printing form to be removed from the effects of light during the oxygen treatment in a subsequent step 22. For example, the printing form can be kept in virtually total darkness by partitioning devices while it simultaneously undergoes an oxygen bath. Preventing light from affecting the surface of the printing form facilitates and accelerates the conversion of the surface into the hydrophobic state.

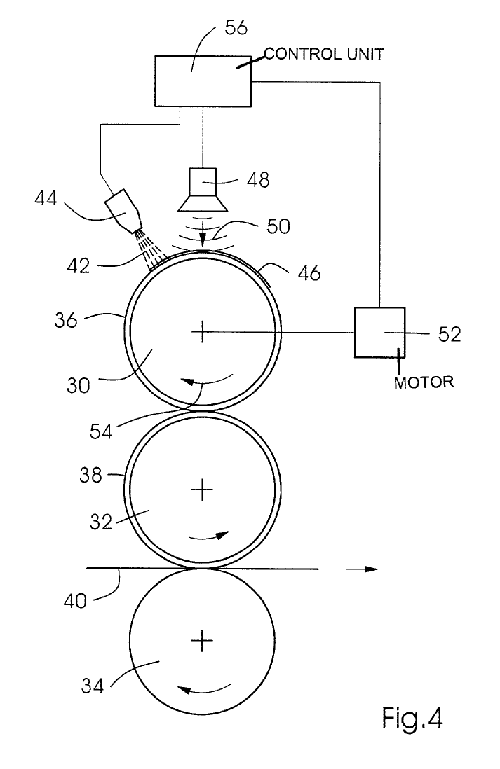

The embodiment of the inventive device represented in FIG. 4 includes a printing form cylinder 30, a rubber blanket cylinder 32, and an impression cylinder 34. A printing image located on the surface of a re-imageable printing form 36 is transferred to a rubber blanket 38 of the rubber blanket cylinder 32 and from there to a recording medium 40, for example, a sheet or web of paper, which runs through the nip between the rubber blanket cylinder 32 and the impression cylinder 34. To clear the re-imageable printing form 36 on the printing form cylinder 30 in an on-press embodiment of the device according to the invention, after the ink is washed from the printing form 36 by a washing device, which is not shown in the figure, the printing form is treated with a liquid clearing medium 42 which is sprayed onto the surface of the re-imageable printing form 36 with the aid of a sprayer 44. The liquid clearing medium forms a thin film 46 on the surface of the re-imageable printing form 36 which extends in the direction of rotation of the printing form cylinder from the location at which the liquid clearing medium 42 is sprayed onto the printing form. The printing form 36 is treated with ultrasound 50 from an ultrasound source 48 that is disposed downline from the sprayer 44 in the direction of rotation of the printing form cylinder 30. During the clearing process, a motor 52 turns the printing form cylinder with the re-imageable printing form 36 thereon in the direction of rotation indicated by the arrow 54. Metering of the clearing medium 42 and intensity of the ultrasound radiation 50 are controlled by a control unit 56. In this regard, it is possible, for example, to detect the printing image or residues of the printing image on the surface of the re-imageable printing form 36 with the aid of a non-illustrated sensor unit, and, based upon this step, to adapt the amount of the liquid clearing medium 42, the point of application of the liquid clearing medium 42 or the local intensity of the ultrasound radiation 50 to the detected printing image or to the as yet uncleared residues thereof for a more efficient clearing process. The control unit 56 also controls the motor 52 for rotating the printing form cylinder 30, so that a purposeful, for example, incremental, slow or fast rotation of the printing form cylinder in the forward and backward directions, respectively, is achievable.

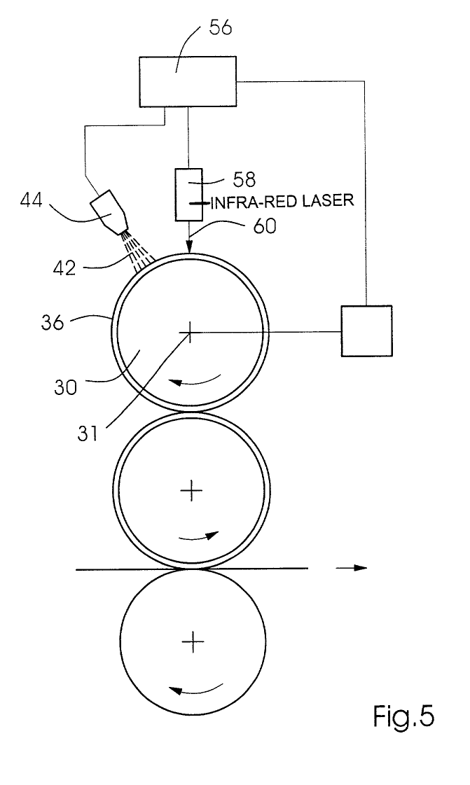

In the embodiment of the device for clearing a re-imageable printing form according to the invention, which is represented in FIG. 5, an infrared laser 58 is disposed downline from the sprayer 44 in the direction of rotation of the printing form cylinder 30. After being treated with the liquid clearing medium 42, the surface of the re-imageable printing form 36 is then treated with infrared radiation 60. The infrared laser unit 58 may be formed here of a single infrared laser 58 having a beam 60 that is movable back and forth across the surface of the re-imageable printing form 36 in the axial direction by a non-illustrated scanning device. Provision may also be made for installing an infra-red laser unit in the form of a linear, axial laser arrangement of several infrared lasers, the laser unit being disposed in the vicinity of the surface of the re-imageable printing form 36 parallel to the axis 31 of the printing form cylinder 30. With the aid of this control unit 56, the power of the infrared laser 58 can be controlled and continuously reduced during the ongoing clearing process.

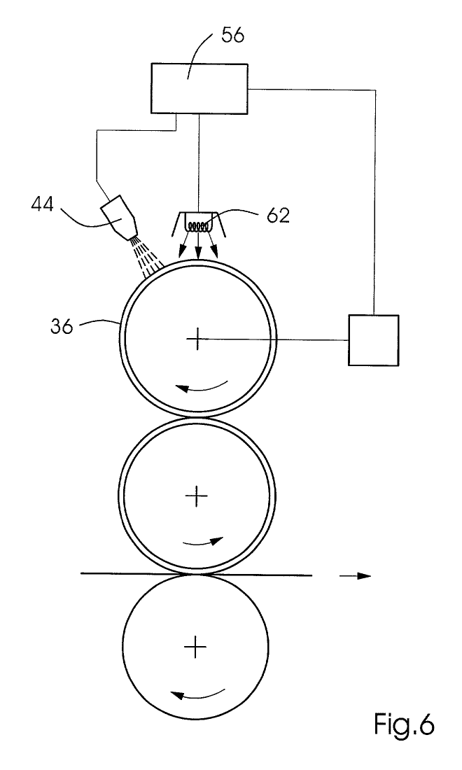

FIG. 6 shows another embodiment of the device according to the invention, with a heat emitter 62 disposed in the vicinity of the surface of the re-imageable printing form 36 adjacent to the sprayer 44 instead of an infra-red laser as in FIG. 5. In this embodiment of the device for clearing the re-imageable printing form, also, it is possible to regulate the output power of the heat source in the form of a heat emitter 62 with the aid of a control unit 56.

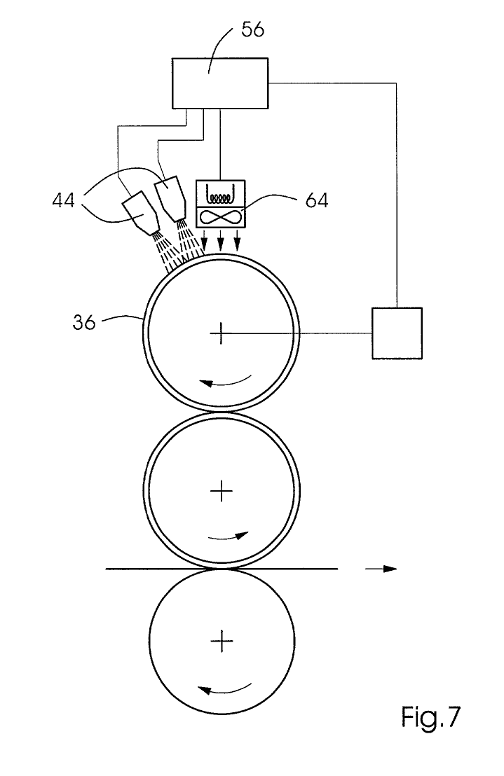

FIG. 7 shows a further embodiment of the device according to the invention wherein a hot-air blower 64 is disposed in the vicinity of the surface of the printing form adjacent to two sprayers 44 for the purpose of heating the surface of the printing form. The utilization of two sprayers 44 makes it possible to apply a clearing medium mixture to the surface of the printing form 36, with the proportion of the first and the second media in the mixture being set by controlled adjustment of metering at the sprayers 44.

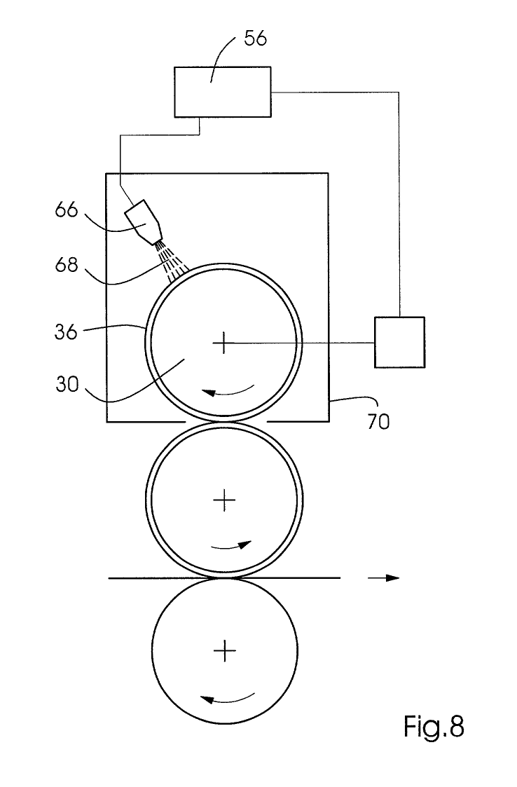

The embodiment of the device according to the invention for clearing a re-imageable printing form, which is represented in FIG. 8, exhibits a jet 66, which blasts or blows oxygen 68 against the surface of the re-imageable printing form 36. In order to achieve an elevated concentration of oxygen in the environmental air of the printing form 36, the printing form cylinder 30 is surrounded by a partitioning device 70, which encloses the printing form cylinder in an optimally gas-tight manner. The amount of oxygen 68 that is delivered can be set by the control unit 56, with the concentration of oxygen within the partitioning device 70 being detected by a non-illustrated sensor unit and compared to a predetermined nominal or desired value.

We claim:

1. A method for clearing a re-imageable printing form, which comprises treating the printing form with a fluid clearing medium.

2. A method for clearing a re-imageable printing form, which comprises cleaning the printing form of ink, and treating the cleaned printing form with a fluid clearing medium.

3. A method for clearing a re-imageable printing form, which comprises treating the printing form with a liquid clearing medium.

4. A method for clearing a re-imageable printing form, which comprises treating the printing form with a gaseous clearing medium.

5. The method according to claim 1, which includes treating the printing form with ultrasound during the treatment thereof with the fluid clearing medium.

6. The method according to claim 1, which includes exposing the printing form to the effects of a heat source during the treatment thereof with the fluid clearing medium.

7. The method according to claim 6, which includes providing at least one of an infrared laser, at least one heat emitter and at least one hot-air blower as the heat source.

8. The method according to claim 6, which includes exposing the printing form to higher than normal atmospheric pressure during the treatment with the fluid clearing medium.

9. The method according to claim 5, which includes providing water as the fluid clearing medium.

10. The method according to claim 1, which includes providing acid as the fluid clearing medium.

11. The method according to claim 1, which includes providing an alkali or a base as the fluid clearing medium.

12. The method according to claim 1, which includes applying the fluid clearing medium to the printing form from at least one sprayer.

13. The method according to claim 4, which includes removing the printing form from the influence of light during the treatment with the gaseous clearing medium.

14. The method according to claim 10, which includes providing oxygen as the gaseous clearing medium.

15. The method according to claim 1, which includes performing the steps thereof in one of a printing machine and a clearing device outside a printing machine.

16. A device for clearing a re-imageable printing form, comprising a device for applying fluid clearing medium to the printing form.

17. A device for clearing a re-imageable printing form washed free of ink, comprising a device for applying fluid clearing medium to the ink-free printing form.

18. The device for clearing a re-imageable printing form according to claim 13, wherein said device for applying fluid clearing medium serves for applying liquid clearing medium to the printing form.

19. The device for clearing a re-imageable printing form, according to claim 13, wherein said device for applying fluid clearing medium serves for applying gaseous clearing medium to the printing form.

20. The device for clearing a printing form according to claim 13, including an ultrasound source for irradiating the printing form with ultrasound.

21. The device for clearing a printing form according to claim 13, including a heat source for heating the printing form.

22. The device for clearing a printing form according to claim 18, wherein said heat source is at least one of an infra-red laser, at least one heat emitter, and at least one hot-air blower.

23. The device for clearing a printing form according to claim 18, including a device for generating higher than normal atmospheric pressure in the environment of the printing form.

24. The device for clearing a printing form according to claim 13, wherein said device for applying fluid clearing medium to the printing form is a sprayer.

25. The device for clearing a printing form according to claim 13, including a device for partitioning the printing form against effects of light.

26. A printing machine having a device for clearing a re-imageable printing form, comprising a device for applying fluid clearing medium to the printing form.
